(19) United States
(12) Patent Application Publication
(10) Pub. No.: US 2008/0275977 A1
(43) Pub. Date: Nov. 6, 2008

(54) METHOD AND SYSTEM FOR MANAGING INFORMATION FEED DELIVERY TO A COMMUNICATIONS DEVICE

(75) Inventors: Roland SCHMIDT, Vancouver (CA); Oren FRIEDMAN, Burnaby (CA)

Correspondence Address: NEXUS LAW GROUP LLP, 1500 - 701 WEST GEORGIA STREET, VANCOUVER, BC, V7Y 1C6, CA

(73) Assignee: CONTEC INNNOVATIONS INC., Port Coquitlam (CA)

(21) Appl. No.: 12/115,363

(22) Filed: May 5, 2008

Related U.S. Application Data
(60) Provisional application No. 60/916,292, filed on May 6, 2007.

(51) Int. Cl. G06F 15/173

(52) U.S. Cl. 709/223

(57) ABSTRACT

A method and system for managing information feed delivery to communications devices is provided. In one aspect, the method involves initializing a user account in response to receiving a first communication identifying a communications device. In another aspect, the method involves associating a content object of an information publisher with an information feed for delivery to a communications device; receiving from the information publisher an updated content object for association with the information feed; and producing in response to the updated content object an updated information feed to replace the information feed. The method may involve delivering to the communications device an information feed in response to receiving an information feed identifier. The method may involve combining translated content objects. The system includes an initialization component; an updating component; and a database for storing an identifier identifying the communications device in association with one or more information feeds.

### CROSS-REFERENCE TO RELATED APPLICATIONS

This application claims priority to provisional application 60/916,292, filed May 6, 2007, and which is incorporated herein by reference.

### BACKGROUND OF THE INVENTION

1. Field of Invention

This invention relates to information technology and communications and, in particular, to a method and system for managing information feed delivery to a communications device.

2. Description of Related Art

Many mobile communications devices, including mobile telephones such as cellular telephones and satellite telephones, personal digital assistants and wireless communications devices, include web browsers for accessing and browsing the Internet and other data communications networks. However, such mobile web browsers are of limited use due to restricted keyboard entry and limited functionality. Thus, it is cumbersome for users to key in usernames and passwords.

Many mobile web browsers included in mobile communications devices are limited in functionality and are not able to receive web feeds such as Really Simple Syndication (RSS) formatted feeds. Software programs such as feed readers have been developed to permit mobile web browsers to receive RSS feeds. However, the user must download and install such software into their mobile communications device, which is inconvenient to the user.

Even with a feed reader installed in the mobile communications device, many mobile web browsers are unable to combine content from non-feed sources and content from feed sources into a single feed that is updated automatically when there is a change in the content from either a non-feed source or a feed source.

### SUMMARY

The above shortcomings may be addressed by providing, in accordance with one aspect of the invention, a method of managing information feed delivery to communications devices involving initializing a user account. The method involves receiving a communication identifying a communications device; generating a communications device identifier for identifying the communications device; and recording the communications device identifier in association with an information feed associated with an information publisher.

Receiving a communication identifying a communications device may involve receiving the communication identifying a mobile telephone number of the communications device. Generating a communications device identifier identifying the communications device may involve generating a passcode associated with the communications device. The method may further involve transmitting the passcode to the communications device. Recording the communications device identifier in association with an information feed associated with an information publisher may involve recording the communications device identifier in association with the communications device and an information feed associated with an information publisher. Recording the communications device identifier in association with an information feed associated with an information publisher may involve recording in a database the communications device identifier in association with the information feed associated with the information publisher. Recording the communications device identifier in association with an information feed associated with an information publisher may involve storing in a database a passcode in association with the information feed. Recording the communications device identifier in association with an information feed associated with an information publisher may involve recording the communications device identifier in association with the mobile telephone number of the communications device. Recording the communications device identifier in association with an information feed associated with an information publisher may involve associating the information feed with the information publisher. Associating the information feed with the information publisher may involve associating a content object of the information publisher with the information feed. Associating the information feed with the information publisher may involve receiving a second communication identifying the information publisher. Receiving a communication identifying the communications device may involve receiving a communication identifying the communications device and identifying the information publisher.

In accordance with another aspect of the invention, there is provided a method of managing information feed delivery to communications devices involving updating information feeds for delivery to communications devices. The method involves associating a content object of an information publisher with an information feed for delivery to a communications device; receiving from the information publisher an updated content object for association with the information feed; and producing in response to the updated content object an updated information feed to replace the information feed.

Receiving from the information publisher an updated content object for association with the information feed may involve retrieving the updated content object from the information publisher after receiving a communication from the information publisher indicating the content object has been updated. Producing in response to the updated content object an updated information feed to replace the information feed may involve producing a translated content object by translating the updated content object from a first language to a second language and associating the translated content object with the updated information feed. Producing a translated content object may involve translating the updated content object from a first language, which is incompatible with a markup language, to a second language, which is compatible with the markup language. Producing a translated content object may involve translating the updated content object from a first language, which is incompatible with Really Simple Syndication (RSS), to a second language, which is compatible with RSS. The method may further involve transmitting the updated information feed to the communications device. Producing a translated content object may involve translating the updated content object from a first language, which is incompatible with an ATOM protocol language, to a second language, which is compatible with the ATOM protocol language. Transmitting the updated information feed to the communications device may involve producing a converted information feed by converting the updated information feed from a first language format to a second language format and transmitting the converted information feed. Producing a converted information feed may involve converting the updated information feed from a first language format, which is incompatible with a browser of the communications device, to a second language format, which is compatible with the browser. Producing a converted information feed may involve converting the updated information feed from a first markup language format to a second markup language format. Producing a converted information feed may involve converting the updated information feed from an extensible markup language (XML) format to a second language format selected from the group consisting of hypertext markup language (HTML), extensible hypertext markup language (XHTML) and wireless markup language (WML). Transmitting the updated information feed to the communications device may involve receiving from the communications device a request for delivery of a requested information feed and transmitting the requested information feed. Transmitting the updated information feed to the communications device may involve transmitting to the communications device one or more identifiers associated with one or more information feeds available for delivery to the communications device, respectively. The method may further involve transmitting to the communications device, after producing the updated information feed, an output communication indicating that the information feed has been updated. Associating a content object of an information publisher with an information feed for delivery to a communications device may involve associating a plurality of content objects of a plurality of information publishers with an information feed, respectively.

In accordance with another aspect of the invention, there is provided a system for managing information feed delivery to a communications device. The system includes an initialization component for associating a communications device with one or more information feeds associated with each of one or more information publishers; an updating component for updating the one or more information feeds; and a database for storing an identifier uniquely identifying the communications device in association with the one or more information feeds.

In accordance with another aspect of the invention, there is provided a computer program product comprising computer executable instructions embodied in a signal bearing medium for performing at least one method described herein.

The signal bearing medium may include at least one of a recordable computer readable medium and a signal transmission type medium.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a block diagram of a system for managing information feed delivery to a communications device according to a first embodiment of the invention and an environment of the system;

FIG. 2 is a flow diagram of a method of managing information feed delivery to communications devices, the method involving initializing a user account within the system shown in FIG. 1;

FIG. 3 is a flow diagram of a method of initializing a user account in accordance with the method shown in FIG. 2;

FIG. 4 is a flow diagram of a detailed method of initializing a user account in accordance with the method shown in FIG. 2;

FIG. 5 is a flow diagram of a method of processing by the system shown in FIG. 1 a communication received which identifies a communications device;

FIG. 6 is a flow diagram of a method of processing by the system shown in FIG. 1 a communication received from a communications device that includes a passcode;

FIG. 7 is a flow diagram of a method of processing by the system shown in FIG. 1 a communication received from a communications device that includes an information feed identifier; and

FIG. 8 is a flow diagram of a method of processing by the system shown in FIG. 1 a communication received from an information publisher indicating a content object has been updated.

### DETAILED DESCRIPTION

A system for managing information feed delivery to a communications device includes initialization means for initializing the system; database means for storing system data; and updating means for updating the system data.

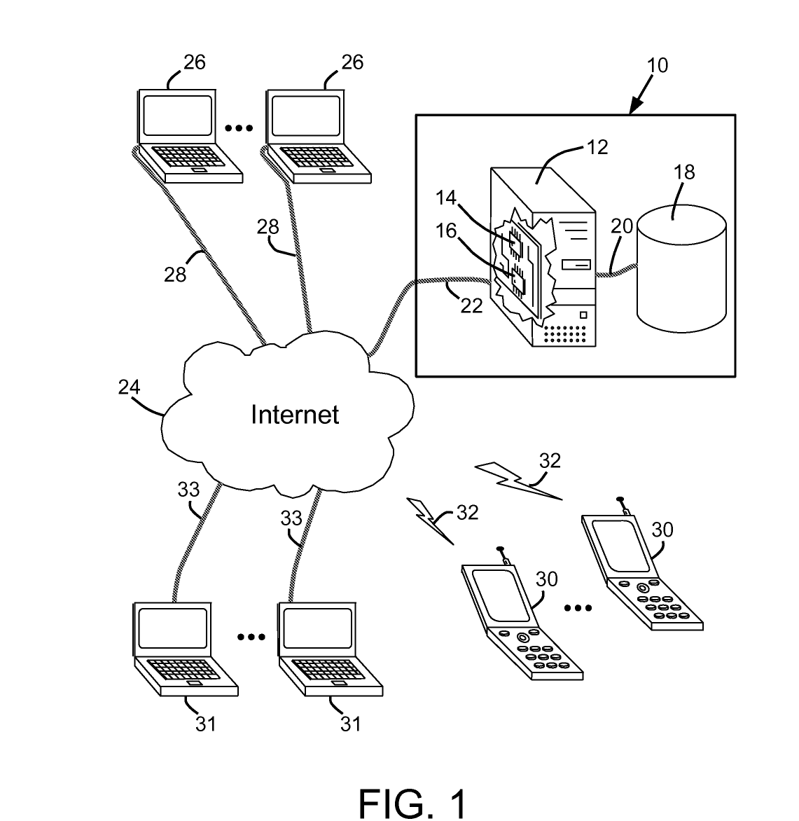

Referring to FIG. 1, the system according to a first and preferred embodiment of the invention is shown generally at 10. The system 10 is operable to perform methods of the present invention, including to initialize user accounts and to manage and update information feeds for delivery to communications devices.

An information feed can include any information or data presentable as a feed such as a web feed document, including information or data presentable, after performing a translation process, as a feed. An information feed typically contains content items obtained from an information publisher, such as a news website, weblog, podcast or other information publisher, for example. The information feed can be formatted according to any standard such as RSS or ATOM. It is not necessary for operability of the present invention for content items to be formatted according to any particular standard when being obtained from an information publisher.

The system 10 includes a server 12 having a processing circuit, such as the processor 14 shown in FIG. 1, and a memory circuit 16. The system 10 also includes a database 18, which is shown in FIG. 1 as being connected to the server 12 by a database connection 20.

The server 12 may be any computing device such as a general purpose computer, microcomputer, minicomputer, mainframe computer, distributed networked computer, functionally equivalent discrete hardware components and any combination thereof, for example.

The processor 14 is typically a processing circuit that includes one or more circuit units, such as a central processing unit (CPU), digital signal processor (DSP), embedded processor, etc., and any combination thereof operating independently or in parallel, including possibly operating redundantly. The processor 14 may be implemented by one or more integrated circuits (IC), including being implemented by a single monolithic integrated circuit (MIC). The processor 14 may include circuitry for storing memory, such as digital data, and may comprise the memory circuit 16 or be in wired communication with the memory circuit 16, for example.

Typically, the memory circuit 16 and the database 18 are each all or part of a digital electronic integrated circuit, and may each be implemented by one or more integrated circuits (IC), including being implemented by a single monolithic integrated circuit (MIC). The memory circuit 16 and the database 18 may be implemented as Read-Only Memory (ROM), Programmable Read-Only Memory (PROM), Erasable Programmable Read-Only Memory (EPROM) or Electrically Erasable Programmable Read-Only Memory (EEPROM), flash memory, one or more flash drives, universal serial bus (USB) connected memory units, magnetic storage, optical storage, magneto-optical storage, and any combination thereof, for example. The memory circuit 16 and the database 18 may be operable to store memory as volatile memory, non-volatile memory, dynamic memory, and any combination thereof.

The database 18 may be implemented as part of the processor 14, the memory circuit 16, or may be implemented separately from the server 12 as shown in FIG. 1. The database 18 typically functions to store information, typically in the form of recordable and retrievable data for use within or by the system 10, including data records stored in association with other data records.

In the first embodiment, the server 12 is connected by a server connection 22 to a communications network such as the network 24 shown in FIG. 1, by way of example, as the Internet. In some embodiments, the database 18 is connected to the server 12 through the network 24 in addition or in the alternative to the database connection 20.

The system 10 is typically operable to run any one or more operating systems, including real-time operating systems, non-real time operating systems, multi-tasking operating systems, and any combination thereof. The system 10 may be operable to implement multi-tasking methods involving multiple threads of executable code, for example.

Source devices 26 are shown in the exemplary arrangement of FIG. 1 as connected via source connections 28 to the network 24 for transmitting content objects or items of an information publisher. The system 10 is operable to obtain content objects, including receiving information feeds, from any number of information publishers including receiving content items transmitted through the network 24 from any of the source devices 26. While FIG. 1 shows exemplary illustrations of source devices 26 as laptop computers, the system 10 is not limited by the type of a source device 26 and is operable to obtain content objects transmitted from any type of computing device operable to transmit content objects across the network 24.

Communications devices such as the mobile telephones 30 of users (not shown) are shown in the exemplary arrangement of FIG. 1 as connected by wireless links 32 to the network 24. In the first embodiment, the system 10 is operable to manage, update or both manage and update information feeds for delivery to a communications device such as any of the mobile telephones 30 shown in FIG. 1. A person of ordinary skill in the art will appreciate that the communications devices are not restricted to the mobile telephones 30 shown in FIG. 1, but can be any number of devices for receiving communications such as cellular telephones, satellite telephones, personal digital assistants, pagers, wireless communications devices, or similar devices.

Any number of network devices 31 can be connected to the network 24 by network connections 33 as shown in FIG. 1. Each network device 31 can be any computing device operable to provide to users network access such as internet access. The server 12, each source device 26 and each network device 31 may be identical, similar or different devices.

### Method of Operation

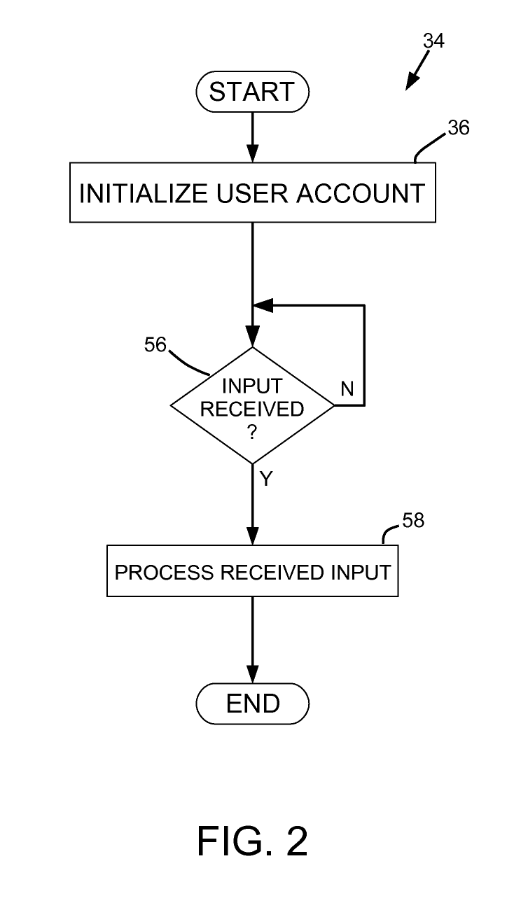

Referring to FIG. 2, the memory circuit 16 in accordance with the first embodiment of the invention contains blocks of code comprising computer executable instructions for directing the processor 14 to perform the steps of a method shown generally at 34.

When electrical power is being supplied to the processor 14 and the memory circuit 16, the processor 14 is directed to begin executing the instructions of block 36, possibly before, after or in conjunction with other tasks the processor 14 is operable to perform. Block 36 directs the processor 14 to initialize a user account.

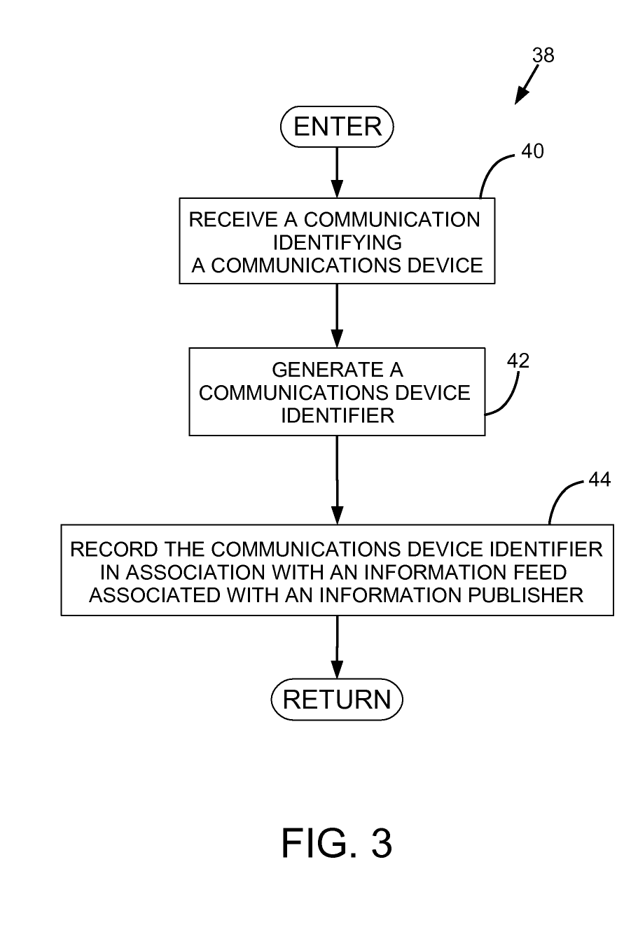

Referring to FIG. 3, a method for initializing a user account in accordance with block 36 (FIG. 2) is shown generally at 38. Block 40 directs the processor 14 to receive a communication identifying a communications device. Typically, the communication is received at the server 12 through the network 24, and may originate from one of the network devices 31, for example.

Block 42 then directs the processor 14 to generate a communications device identifier for identifying the communications device.

Block 44 directs the processor 14 to record the communications device identifier in association with an information feed associated with an information publisher.

A person of ordinary skill in the art will appreciate that the steps of method described herein and illustrated in accompanying figures need not necessarily be performed in the exemplary order described and illustrated herein, unless stated otherwise. After blocks 40 to 44 have been executed, the processor 14 is directed to end the method 38 and return to the method 34 of FIG. 2.

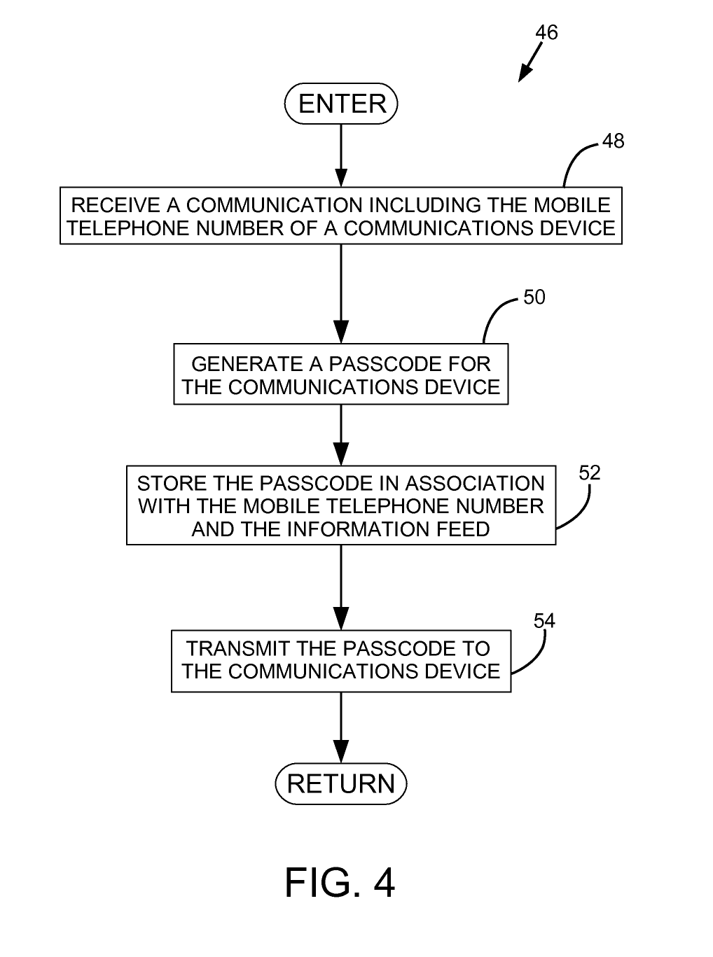

In FIG. 4, a detailed exemplary method in accordance with block 36 (FIG. 2) is shown generally at 46. Block 48 directs the processor 14 to receive a communication, which includes the mobile telephone number associated with a communications device. Typically, the communications device is a mobile telephone 30 (FIG. 1) and has assigned to it a unique mobile telephone number that uniquely identifies that mobile telephone 30.

In general, the communication may not have been transmitted to the processor 14 in response to any activity of the system 10. Typically an information publisher operable to use system 10 services has installed therein a link or other executable code associated with a web page that displays on the web page a web page button indicating that an RSS feed, ATOM feed, data or other information feed can be delivered to the user's mobile telephone 30 (FIG. 1). A user operating a network device 31 and displaying the web page, such as by displaying the web page on a browser of the network device 31 when the network device 31 is connected to the network 24, is typically permitted by the web page to select the web page button. When the user selects the web page button, a link to the system 10 is activated and the network device 31 becomes connected through the network 24 to the system 10. In the first embodiment, the system 10 is operable to request that the user enter in the mobile telephone number of their mobile telephone 30. The system 10 may also be operable to implement other security and anti-spam measures, such as requiring the user to type in an alphanumeric code displayed graphically to prevent multiple automated entries of mobile telephone numbers. When the user has entered in the mobile telephone number, it is then transmitted to the system 10 via the network 24 as a communication to the system 10 that includes the entered mobile telephone number. In the first embodiment, the system 10 is operable to receive the communication with the entered mobile telephone number and determine whether a user account already exists for that entered mobile telephone number. If a user account already exists, then initialization of the user account is not necessary and other processing steps are taken, as described further herein below. Activating the link to the system 10 also identifies to the system 10 the information publisher and, in some embodiments, also specifies one or more content objects published by the information publisher for inclusion in an information feed associated with that information publisher.

In the case where a user account does not already exist, block 50 directs the processor 14 to generate a passcode identifying the communications device. Preferably, the passcode is generated for identifying the communications device in association with an information feed associated with the information publisher. The passcode can be any password, passphrase, alphanumeric code or other identifying means for identifying the given user's mobile telephone 30 (FIG. 1). In some embodiments, the passcode is the entered mobile telephone number itself. In the first embodiment, the passcode is an alphanumeric code separate from the entered mobile telephone number, and may comprise a multiple character alphanumeric code, such as a number, which can be appended to the entered mobile telephone number. Such separate passcode advantageously inhibits unauthorized use of a mobile telephone number to create a user account for another person's mobile telephone 30.

Block 52 then directs the processor 14 to store the passcode in association with the mobile telephone number and the information feed associated with the information publisher. In the first embodiment, the system 10 stores the passcode in the database 18. Additionally or alternatively, the content objects associated with the information feed may also be stored in the database 18 for later retrieval.

Block 54 then directs the processor 14 to transmit the passcode to the communications device such as the given mobile telephone 30 (FIG. 1). The system 10 is operable to transmit a Short Messaging Service (SMS) communication, Multimedia Messaging Service (MMS), a voice communication, and combinations thereof, for example. In the first embodiment, the processor 14 is directed to transmit a SMS message or similar to the given mobile telephone 30 which includes an invitation to receive an information feed. The SMS message typically includes a Uniform Resource Identifier (URI), such as a Uniform Resource Locator (URL) or an Uniform Resource Name (URN), that can be selected by the user. The URI typically includes a URL comprising a main URL of the server 12 and URL parameters for the system 10 to identify the given mobile telephone 30. In the first embodiment, the parameters include the passcode and may include the passcode appended to the entered mobile telephone number. When the user selects the URL included with the invitation, the mobile web browser of the mobile telephone 30 transmits a communication to the system 10 that includes the passcode. Many mobile telephones 30 are operable store the URL, possibly by storing the SMS message that includes the URL, for later use of the passcode by the user.

After block 54 has been executed, the processor 14 is directed to return to the method 34 of FIG. 2.

Block 56 directs the processor 14 to determine whether an input has been received by the system 10. If no input has been received, the processor 14 is directed to return to block 56 itself, thereby permitting the system 10 to wait for a received input. When an input has been received, the processor 14 is directed to execute block 58.

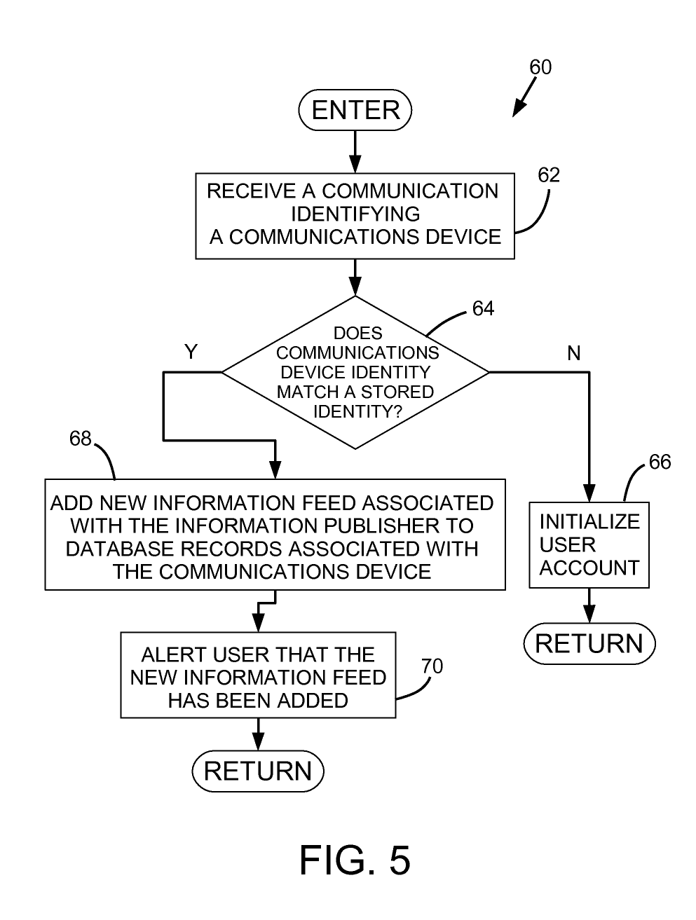

Block 58 directs the processor 14 to process the received input. Such processing depends at least in part on the received input. In the first embodiment, the system 10 can be implemented using a multi-tasking operating system such that the system 10 is operable to process multiple inputs simultaneously or apparently simultaneously rather than sequentially, for example. Exemplary inputs that can be processed by the system 10 and processing thereof are described herein below with reference to FIGS. 5, 6, 7 and 8.

FIG. 2 shows the method 34 as ending after block 58 has been executed. However, the system 10 is operable in some embodiments to continually monitor for new inputs being received, and to process such inputs as they are received.

Referring to FIG. 5, a method of processing a communication received which identifies a communications device for which a user account already exists is shown generally at 60. Block 62 directs the processor 14 to receive a communication identifying a communications device. Typically, the communication is received from a network device 31 through the network 24. Block 62 may be executed in a manner identical, similar, analogous or different to that of block 40 (FIG. 3), for example. By way of example, the communications device may be a mobile telephone 30 (FIG. 1) and the received communication may identify the mobile telephone 30 by its mobile telephone number. In the case where the system 10 determines from the mobile telephone number that a user account for that mobile telephone number already exists, the system 10 in the first embodiment prompts the user to input their passcode. The system 10 is operable to receive the passcode from the network device 31. In the first embodiment, the system 10 combines the mobile telephone number and the passcode to form a communications device identity. The inclusion of both the mobile telephone number and the passcode in the communications device identity advantageously inhibits unauthorized additions of new information feeds. However, in some embodiments, the communications device identity includes only the mobile telephone number. In some embodiments, the communications device identity includes only the passcode.

Block 64 directs the processor 14 to determine whether the communications device identity matches a stored identity, which in the first embodiment may be stored in the database 18.

If no match is found, block 66 directs the processor 14 to initialize a user account for the new user. Block 66 may be executed in a manner identical, similar or analogous to that of block 36 (FIG. 2), for example. When block 66 has been executed, the processor 14 is directed to return to the method 34 of FIG. 2.

If a match between the communications device identity and a stored communications device identity is found, then block 68 directs the processor 14 to add a new information feed associated with the appropriate information publisher to the database 18 records associated with the communications device. Adding a new information feed may involve storing a information feed source identifier, such as a link or pointer to the information publisher or to content objects of the new information feed, storing content objects currently making up the new information feed, or any combination thereof, for example.

Block 70 directs the processor 14 to alert the user that the new information feed has been added. Alerting the user may involve transmitting a communication to the communications device, and such communication may include an invitation to receive the new information feed. Additionally or alternatively, alerting the user may involve transmitting the passcode previously generated for the mobile telephone 30 (FIG. 1) associated with the communications device identity. Block 70 may be implemented in a manner identical, similar or different from that of block 52 (FIG. 4), for example.

Block 70 is optionally executed in some embodiments. In the first embodiment, the system 10 is operable to receive user input from the user indicating whether the user would like to be alerted each time a new information feed has been added. If the user has indicated that the system 10 should provide such alert, then block 70 is executed. If the user has indicated that the system 10 should not provide such alert, then the processor 14 is directed to return to the method 34 (FIG. 2) after executing block 68 and without executing block 70.

After block 70 has been executed, the processor 14 is directed to return to the method 34 of FIG. 2.

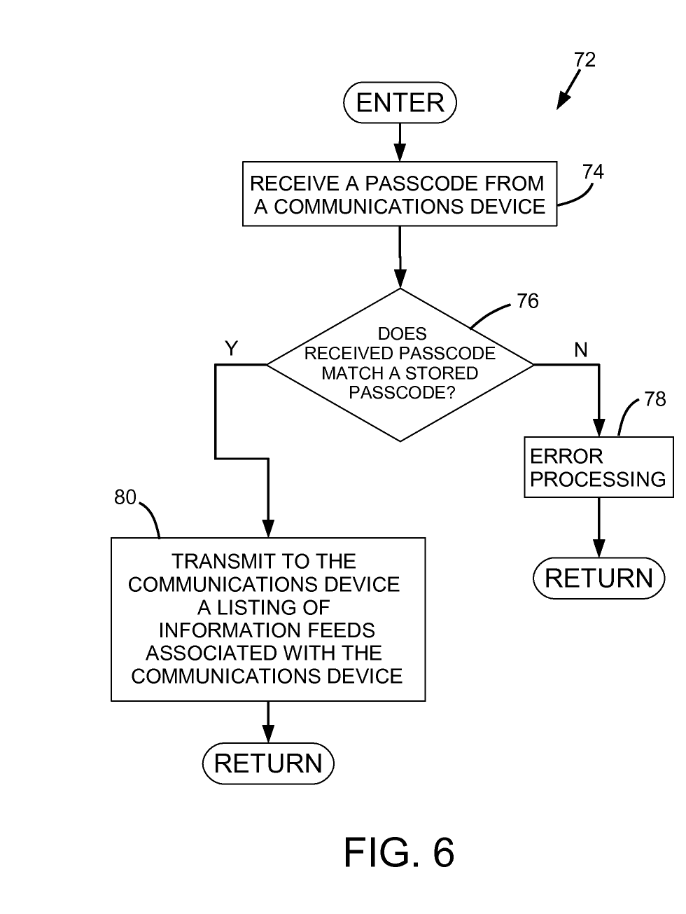

Referring to FIG. 6, a method of processing a communication received from a communications device that includes a passcode associated with a communications device for which a user account already exists is shown generally at 72. Block 74 directs the processor 14 to receive a passcode from a communications device. In the first embodiment, the system 10 is operable to receive the passcode as a parameter portion of a URL selected by the user using the web browser of the user's mobile telephone 30 (FIG. 1).

Block 76 directs the processor 14 to determine whether the passcode received by block 74 matches a stored passcode. In some embodiments, the system 10 is also operable to determine whether the received passcode matches the stored passcode associated with the mobile telephone number of the mobile telephone 30 (FIG. 1) from which the passcode was received.

If no match is found, or if an improper match is found, by block 76 then the processor 14 is directed to block 78 which directs the processor 14 to perform error processing. Such error processing may include verifying the contents of the database 18, ignoring the received passcode, attempting to communicate with the mobile telephone 30 (FIG. 1), such as by sending a SMS message or similar, from which the passcode was received, or other error processing steps and any combination thereof. After block 78 has been executed, the processor 14 is directed to return to the method 34 of FIG. 2.

If a match between the received passcode and a stored passcode is found, then the processor 14 is directed to execute block 80. Additionally or alternatively, block 80 may be executed only if the received passcode matches the stored passcode and the mobile telephone number of the sending mobile telephone 30 (FIG. 1) matches the mobile telephone number associated with the stored passcode.

Block 80 directs the processor 14 to transmit to the communications device, which may be the requesting mobile telephone 30 (FIG. 1) associated with the matched and stored passcode, a listing of information feeds associated in the database 18 with the requesting mobile telephone 30. Transmitting the listing may involve sending to the mobile web browser of the requesting mobile telephone 30 instructions to display a personal page on a display of the requesting mobile telephone 30, for example. The listing may include one or more URLs for each information feed available for delivery to the mobile telephone 30 that has been previously associated with the requesting mobile telephone 30, for example.

In some embodiments, the system 10 is operable to transmit within or in addition to a listing of information feeds other information and data. The system is generally not limited to transmitting conventional data feeds such as RSS feeds or ATOM feeds.

In some embodiments, block 80 may also be executed immediately after initializing a new user account, without further input from the user's communications device being required. Executing block 80 immediately after initializing the user account advantageously provides to the user the listing of their personal page upon initialization of that user's account. After an account has been initialized, but before the user has initiated any activity in respect of their account, only one information feed is typically associated with the new communications device.

After block 80 has been executed, the processor 14 is directed to return to the method 34 of FIG. 2.

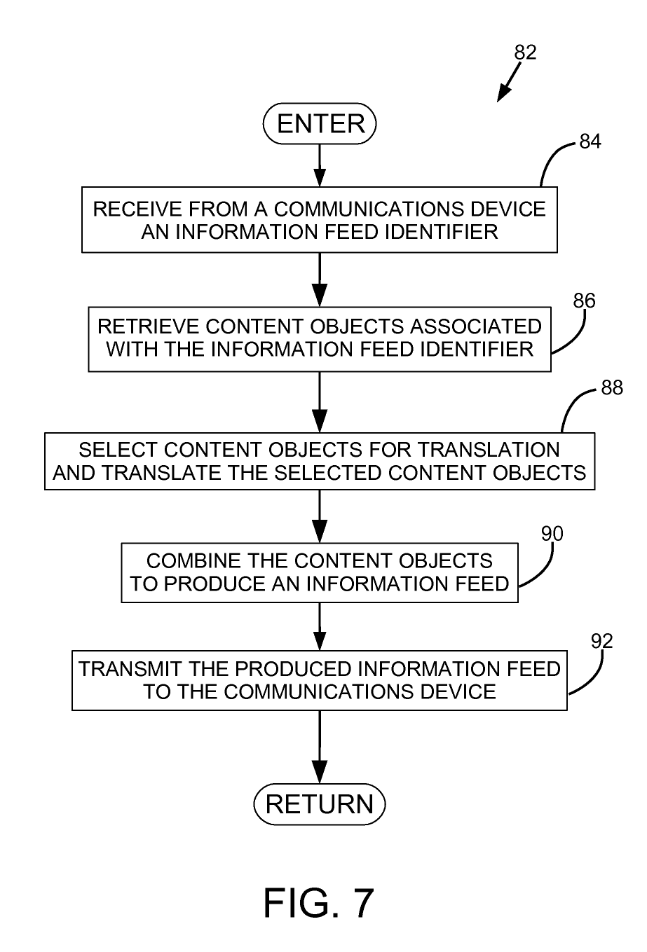

Referring to FIG. 7, a method of processing a communication received from a communications device that includes an identifier associated with an information feed is shown generally at 82. Block 84 directs the processor 14 to receive from a communications device such as a given mobile telephone 30 (FIG. 1) an information feed identifier. Typically, the information feed identifier identifies an information feed requested by the user of the communications device. The information feed identifier may be any combination of alphanumeric characters, a URL, a pointer, a macro, executable code, or any combination thereof that serves to identify an information feed, for example. The information feed identifier may include three parameters: a system 10 parameter, such as a main URL of the server 12, a source parameter for identifying the information publisher and a feed parameter for identifying a particular feed of the information publisher. For example, in the exemplary information feed identifier http://rss.servername.com/feedname.provider.com/, the system 10 parameter is the portion “http://rss.servername.com”, the source parameter is “provider.com” and the feed parameter is “feedname”.

In the first embodiment, the system 10 is operable to receive an information feed identifier from the given mobile telephone 30 (FIG. 1) after the user has selected the information feed identifier from a personal page listing of information feeds displayed on a display of the mobile telephone 30. Additionally or alternatively, the system 10 is also preferably operable to receive an information feed identifier from any mobile web browser whether or not selected from a personal page listing. In some embodiments, the system 10 is operable to receive an information feed identifier from a given mobile telephone 30 even if no user account has been initialized in respect of the given mobile telephone 30.

Block 86 then directs the processor 14 to retrieve one or more content objects associated with the information feed identifier. Typically, the content objects are objects of data or other information for inclusion in the information feed requested by the user of the communications device such as the given mobile telephone 30 (FIG. 1). In the first embodiment, the content objects are retrieved from the information publisher associated with the requested information feed. Additionally or alternatively, however, the content objects may be retrieved from the database 18 in cases where such content objects have been previously stored in the database 18 for later retrieval. In some embodiments, the system 10 is operable to retrieve content objects not expressed in a standard feed format such as RSS or ATOM.

Retrieving a content object associated with an information feed identifier may involve determining whether the content object is located externally to the system 10 or located within the system 10, such as being stored in the database 18. Making such determination in some embodiments involves identifying the source parameter from the information feed identifier. In some embodiments, the information feed identifier includes the source parameter, and the system 10 is operable to parse the information feed identifier to obtain the source parameter. By way of example, the system 10 may be operable to obtain the source parameter “provider.com” from the exemplary information feed identifier http://rss.servername.com/feedname.provider.com/ by parsing the exemplary information feed identifier. Additionally or alternatively, the database 18 may have stored therein a table, associated records or other structured data means to enable the processor 14 to obtain an associated source parameter from a given information feed identifier. By way of example, the system 10 may be operable to obtain the source parameter “provider.com” from the exemplary information feed identifier http://p1.servername.com/feedname by parsing the exemplary information feed identifier to obtain the portion “p1” and mapping the portion “p1” to the source parameter “provider.com”. In general, the system 10 may be operable to map one or more portions of an information feed identifier to parameters associated with the information feed identifier, respectively, thereby advantageously enabling a user to request an information feed by invoking a shortened version of an information feed identifier.

Retrieving an external content object may involve generating an information feed URL according to requirements of the external information publisher associated with the external content object. The system 10 is preferably operable to apply different rules for different information publishers when generating information feed URLs. By way of example, an external information publisher may be identified by the source parameter “provider.com”, and the system 10 may be operable to produce the exemplary information feed URL http://feedname.provider.com/feed. For a different information publisher associated with a different source parameter, such as “provider2.com”, the system 10 may generate the information feed URL http://provider2.com/feedlist?atom.xml, for example.

The system 10 is operable in the first embodiment to retrieve content objects stored within the system 10, such as being stored in the database 18, according to internal rules of the system 10.

In some embodiments, the system 10 is operable to include in personal page listings for selection by users information feed identifiers in which the source parameter and the feed parameter portions thereof are together equivalent to the required information feed URL, thereby enabling the system 10 to advantageously determine the information feed URL by parsing it directly from the information feed identifier.

Block 88 then directs the processor 14 to select zero or more content objects for translation and translate the selected content objects. Typically, the content objects selected for translation are those not expressed in a standard feed format such as RSS or ATOM, or otherwise not in an information feed output format of the system 10. The system 10 is then operable to translate the selected content objects from their native format to the information feed output format of the system 10, which may be a standard feed format such as RSS for example. In the case where all retrieved content objects are already in the information feed output format of the system 10, then typically zero content objects will be selected and block 88 will be executed without performing any translation.

Block 90 then directs the processor 14 to combine the one or more retrieved and possibly translated content objects to generate a produced information feed. The system 10 is operable to combine the content objects in any desired order, including in chronological order by time stamp associated with each content object, for example. Additionally or alternatively, the system 10 may be operable to combine the content objects in accordance with a user preference. In some embodiments, the system 10 is operable to stored the produced information feed in the database 18 for later retrieval.

Block 92 then directs the processor 14 to transmit the produced information feed to the communications device such as the given mobile telephone 30 (FIG. 1). Transmitting the produced information feed may include converting the produced information feed from a first language format, including any markup language such as extensible markup language (XML) for example, to a second language format, such as hypertext markup language (HTML), extensible hypertext markup language (XHTML), wireless markup language (WML), a markup language associated with an i-mode service, similar variations of such language formats, and any combination thereof for example. Converting the language format of the produced information feed advantageously enables the system 10 to transmit information feeds to mobile telephones 30 in a language format most suitable for each of the mobile telephones 30. In the first embodiment, the system 10 is operable to determine a type of the web browser of the given mobile telephone 30 from which the information feed identifier was received, and to convert the language format of the produced information feed in accordance with the type, such that the system 10 transmits the produced information feed in a compatible language format for the given mobile telephone 30.

After block 92 has been executed, the processor 14 is directed to return to the method 34 of FIG. 2.

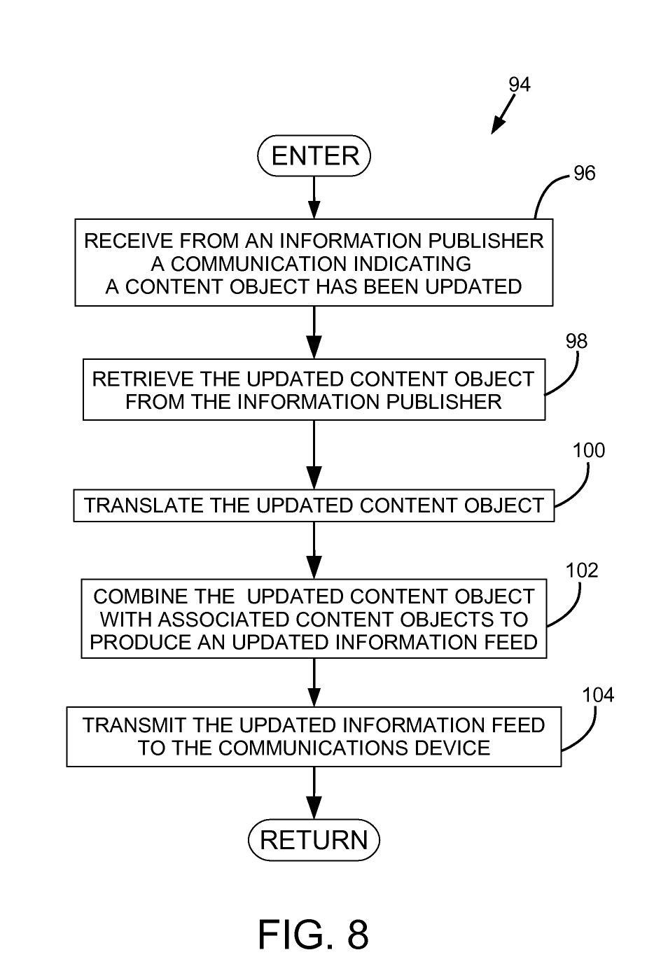

Referring to FIG. 8, a method of processing a communication received from an information publisher that indicates a content object has been updated is shown generally at 94. Block 96 directs the processor 14 to receive from an information publisher a communication indicating that a content object has been updated, including being updated by having the content object, or a portion thereof, deleted, newly added, altered or otherwise changed in some way. In some embodiments, the system 10 is operable to receive from an information publisher a communication indicating that a plurality of content objects have been changed. In some embodiments, the system 10 is operable to receive from an information publisher a communication indicating an information feed associated with content objects of the information publisher has been changed. Typically, the communication may include one or more content object identifiers identifying updated content objects, one or more information feed identifiers identifying information feeds associated with updated content objects, one or more content objects for inclusion in an updated information feed, and any combination thereof, for example.

Block 98 then directs the processor 14 to retrieve the updated content object from the information publisher. Block 98 and block 86 (FIG. 7) may be implemented in an identical, similar, analogous or different manners in various embodiments of the invention. Retrieving the updated content object may involve retrieving the updated content object from the communication received at block 96. Additionally or alternatively, retrieving the updated content object may involve obtaining identifying information from the communication received at block 96 and using such identifying information to request the updated content object from the information publisher. In the first embodiment, the system 10 is operable to retrieve a plurality of updated content objects.

Block 100 then directs the processor 14 to translate the updated content object. Block 100 is optionally executed in some embodiments and may be executed without performing any translations. In the first embodiment, the system 10 is operable to select zero or more content objects among the one or more updated content objects retrieved by block 98, and translate the selected content objects. Block 100 may be implemented in a manner identical, similar, analogous or different to that of block 88 (FIG. 7), for example.

Block 102 then directs the processor 14 to combine the updated content object with zero or more content objects associated with the same information feed to produce an updated information feed. Block 102 and block 90 (FIG. 7) may be implemented in identical, similar, analogous or different manners, for example. In some embodiments, the system 10 is operable to store the updated information feed, including storing the updated information feed in the database 18, for later retrieval such as after a user has requested the updated information feed.

In some embodiments, the system 10 is operable to perform each of steps 98, 100 and 102 immediately after receiving the communication of block 96.

Additionally or alternatively, the system 10 may be operable to delay executing such blocks, including delaying the execution of block 102, delaying the execution of blocks 100 and 102, or delaying the execution of blocks 98, 100 and 102, and execute such blocks at a later delayed time, including after a request for an associated information feed has been received from a communications device, for example.

Block 104 then directs the processor 14 to transmit the updated information feed to the communications device such as the given mobile telephone 30 (FIG. 1). Block 104 and block 92 (FIG. 7) may be implemented in identical, similar, analogous or different manners, for example. In some embodiments, the system 10 is operable to delay transmitting the updated information feed until after receiving from the communications device a request for the updated information feed. Additionally or alternatively, however, the system 10 may be operable to transmit the updated information feed to one or more communications devices associated in the records of the database 18 with the updated information feed. In some embodiments, the system 10 is operable to enable a user to select whether or not to have updated information feeds transmitted to the user's communications device at each update thereof, or only upon request by the user for the transmitting of one or more information feeds.

After block 104 has been executed, the processor 14 is directed to return to the method 34 of FIG. 2.

While embodiments of the invention have been described and illustrated, such embodiments should be considered illustrative of the invention only. The invention may include variants not described or illustrated herein in detail. For example, the system 10 may be operable to inject content objects or other information, such as advertisements or other promotional material, not obtained from an information publisher, not requested by a user, or neither obtained from an information publisher nor requested by a user, into an information feed for delivery to a communications device. Thus, the embodiments described and illustrated herein should not be considered to limit the invention as construed in accordance with the accompanying claims.

What is claimed is:

1. A method of managing information feed delivery to a communications device, the method comprising initializing a user account by:
(a) receiving a communication identifying the communications device;
(b) generating a communications device identifier for identifying the communications device; and
(c) recording said communications device identifier in association with an information feed associated with an information publisher.

2. The method of claim 1 wherein receiving said communication identifying the communications device comprises receiving a mobile telephone number of the communications device.

3. The method of claim 1 wherein receiving said communication identifying the communications device comprises receiving said communication identifying said information publisher.

4. The method of claim 1 further comprising receiving a second communication identifying said information publisher.

5. The method of claim 1 wherein generating said communications device identifier identifying the communications device comprises generating a passcode and associating said passcode with the communications device, and further comprising transmitting said passcode to the communications device.

6. The method of claim 1 wherein recording said communications device identifier in association with said information feed associated with said information publisher comprises associating said information feed with a content object of said information publisher.

7. The method of claim 1 further comprising updating said information feed by:
(a) receiving from said information publisher an updated content object associated with said information feed; and
(b) producing an updated information feed in response to said updated content object.

8. The method of claim 7 wherein receiving from said information publisher said updated content object comprises:
(a) receiving an update communication from said information publisher indicating said content object has been updated; and
(b) after receiving said update communication, retrieving said updated content object from said information publisher.

9. The method of claim 7 wherein producing said updated information feed in response to said updated content object comprises:
(a) producing a translated content object by translating said updated content object from a first language to a second language; and
(b) associating said translated content object with said updated information feed.

10. The method of claim 9 wherein producing said translated content object comprises translating said updated content object from a first language incompatible with a markup language to a second language compatible with said markup language.

11. The method of claim 9 wherein producing said translated content object comprises translating said updated content object from a first language incompatible with a RSS format to a second language compatible with said RSS format.

12. The method of claim 9 wherein producing said translated content object comprises translating said updated content object from a first language incompatible with an ATOM format to a second language compatible with said ATOM format.

13. The method of claim 9 wherein associating said translated content object with said updated information feed comprises combining said translated content object with one or more content objects other than said translated content object.

14. The method of claim 7 further comprising transmitting said updated information feed to the communications device by:
(a) producing a converted information feed by converting said updated information feed from a first language format to a second language format; and
(b) transmitting said converted information feed to the communications device.

15. The method of claim 14 wherein producing said converted information feed comprises converting said updated information feed from a first markup language format incompatible with a browser of the communications device to a second markup language format compatible with said browser.

16. The method of claim 14 wherein producing said converted information feed comprises converting said updated information feed from an extensible markup language (XML) format to a second language format selected from the group consisting of hypertext markup language (HTML), extensible hypertext markup language (XHTML) and wireless markup language (WML).

17. The method of claim 7 further comprising transmitting said updated information feed to the communications device by:
(a) receiving from the communications device a request for delivery of a requested information feed; and
(b) transmitting said requested information feed to the communications device.

18. The method of claim 17 further comprising transmitting to the communications device one or more information feed identifiers, each said information feed identifier being associated with one or more information feeds available for delivery to the communications device.

19. The method of claim 18 wherein receiving from the communications device said request for delivery of said requested information feed comprises receiving said one or more information feed identifiers.

20. A computer program product comprising computer executable instructions embodied in a recordable computer-readable medium for performing the method of claim 1.

21. A system for managing information feed delivery to a communications device, the system comprising:
(a) a database;
(b) an initialization component for initializing a user account, said initialization component being operable to generate and store in said database a passcode for identifying the communications device;
(c) a feed generating component for producing an information feed, said feed generating component being operable to combine one or more content objects with zero or more translated content objects;
(d) a delivery component for delivering to the communications device said information feed in response to receiving from the communications device an information feed identifier; and
(e) an updating component for updating said information feed.
